(19) United States
(12) Patent Application Publication
(10) Pub. No.: US 2016/0312338 A1
(43) Pub. Date: Oct. 27, 2016

(54) High hot creep resistant alloys, parts, systems and methods

(71) Applicant: John Hart Miller, Aurora, CO (US)

(72) Inventor: John Hart Miller, Aurora, CO (US)

(21) Appl. No.: 14/545,381

(22) Filed: Apr. 27, 2015

(51) Int. Cl. C22C 5/04; B22D 21/02; B23K 26/342; B22D 7/00; B22F 3/105; B22D 23/00; B22D 25/02

(52) U.S. Cl. CPC C22C 5/04; B22D 23/00; B22D 21/022; B22D 25/02; B22D 7/005; B22F 3/1055; B23K 26/342

(57) ABSTRACT

Parts having superior high temperature hot creep strength over extended time of as much as 3-9 months or more comprised of one or more precious metals of the platinum family and optionally other alloying metals with a common characteristic of a high rhodium content. The parts are particularly useful at high temperatures in contact with molten glass or molten ceramics such as fiberizing bushings. Different portions of the parts can also be made up of different metals and/or different alloys. Systems and methods are also disclosed for making these parts including hot forging, hot rolling, hot pressing, casting, continuous strip/sheet casting, casting multiple layers, selective laser melting and selective laser sintering.

The present invention includes high hot creep strength and high hot sag resistant precious metal and precious metal alloys, often having high Rhodium (Rh) content Platinum (Pt)—Rh alloy parts having superior hot creep or sag resistance at temperatures at and above about 2000 degrees F. and methods of making and using the parts including glass fiber forming bushings and other glass contacting parts.

This application claims the benefit of the filing date of Provisional application No. 61/996,440 filed on May 7, 2014.

### BACKGROUND

Rhodium (Rh) has been used in precious metal alloys, particularly in platinum (Pt) and platinum-palladium (Pd) alloys for many years to increase the hot creep strength of Pt and Pd while utilizing the inert properties, anti corrosive, properties of the precious metals, particularly for use in, above and around molten materials like glass, inorganic oxides and other inorganic melts, and for use as a container (crucibles) for molten glass, molten oxides, etc. The oxidation resistance of the Rh plus its ability to substantially increase the hot creep strength of precious metals has made it an alloying agent of choice for such purposes, except for one thing, its apparent price, particularly its past prices per troy oz. and the volatility of its price and the difficulty of forming alloys containing more than about 20-25% Rhodium.

In the past 25 years, the price of Rh has varied from as low as about $300 per troy oz. to about $10,000 per troy oz., the latter price occurring as recently as 2008. Rhodium or rhodium ore has not been found in concentrations economical to mine so rhodium mines do not exist. Instead, rhodium is present in very small amounts in some platinum deposits and in some nickel deposits and in very small percentages with other elements so its availability is very limited and dependent on the rate of mining of these other elements and compounds. About 80% of all rhodium is used as catalysts and therefore its availability and price are greatly influenced by the rate of production of petroleum products, cars, trucks, etc. It is also used in jewelry, electrical components such as thermocouples and contacts and in the glass industry for protective sheaths for refractory parts, for forming and containing molten glass and for use in applications where the temperature exceeds about 1800 degrees F.

In the fabrication of parts from Pt—Rh alloys, like 10-20 Rh-80-90 Pt, the alloys are first melted and cast into ingots. The ingots are then pressed, forged or rolled into plates and sheets with the need to anneal one or more times during this process to relieve built in stresses to avoid rupturing and/or warping the alloy shapes. The plates and sheets are then cut to size, drilled if holes are necessary, and when necessary, bent to various angles to form a desired assembly of parts, usually by well known welding techniques for these types of alloys. Usually several annealing steps are required, particularly when forging and rolling are involved, such as the forming of orifice plates or tip plates for glass fiber forming bushings and often such plates still contain residual stresses that detract from the potential life of the bushings in which they are used. Typically, failure of the orifice plates or tip plates due to excessive hot creep, sag, and/or rupture determines the life of the bushings.

In the glass industry Pt—Rh alloys are used as protective sheaths for refractory plungers, throats, and small pipes for withdrawing melt from the melting furnace, and for conditioning melt and forming continuous glass filaments. The percentage of Rh has been limited to 20-27 wt. percent because of cost and ability to fabricate. Fabrication above about 20 wt. percent Rh is more difficult because of he hardness and reduced ductility of the alloys making bending and forging and rolling to the desired thinness very difficult. Consequently, use of Pt/Rh alloys containing more than a few percent above 20 percent Rh has been very limited at best. For this reason, dispersion of non-metallic particles such as oxides, e.g. (zirconia), nitrides, etc. were developed to further increase the hot creep resistance. As the fiber forming devices, bushings, have become larger, hot creep or sag, particularly of the bottom plate of the bushing, the tip plate or orifice plate, has again become a life limiting and costly problem. The glass industry badly needs materials having substantially higher resistance to hot creep at temperatures exceeding about 2000 or 2100 degrees F. for long time periods of several weeks, months and longer. Also, as technology advances and more high temperature applications have and continue to develop, the need for better performing and/or lower cost alloys grows.

### SUMMARY OF THE INVENTION

The invention includes Pt—Rh alloy parts containing 25, 30, 35 or 41 or more than 41 volume weight % Rh, and/or Rhenium (Re) such as more than 42, 43, 44, 45, 46, 47, 48, 49, 53.5, 55, 60 or 61 vol.% Rh in the Pt—Rh alloy parts that need high hot creep resistance, e. g. for use at temperatures exceeding 2000 deg. F, 2100 deg. F. or higher for several weeks, months or even years, parts including those in contact with molten inorganic material including glasses, molten slags, molten rocks and the like. Such parts include fiberizing parts like spinner heads and bushing parts including orifice plates, tip plates, screens, terminals, reinforcing parts, and the like including sheaths, plungers, dams, lips, weirs, etc. When the Rh content exceeds about 25-27 wt. %, the alloy is very difficult to roll, bend, etc., steps typically used to fabricate Pt—Rh alloy parts, such as parts for a bushing, like tip plates, tip plate reinforcements, sidewalls, terminals, etc. The higher Rh content parts of the invention will often require less capital expenditure than the conventional lower 80 Pt/20 Rh content Pt—Rh parts require, particularly when the Rh is bought during depressed Rh prices in the precious metal (PM) or refractory metal (RM) markets. Further, with the parts being made to specific dimensions and the density of Rh being substantially less than the density of Pt substantially less weight of alloy is required according to this invention. Further, the Re content can be present in a much less percentage than those mentioned above, such as when Re is added to improve the malleability and forming properties of other high hot creep and sag resistant metals and alloys described herein.

The invention also includes systems and methods of making parts and various apparatus of high Rh content Pt—Rh alloys by one or more of the following methods;

1) forming a shape or part by casting a high Rh alloy to shape from a melt followed by cold or warm (2000-2500 degrees F. or below) forming techniques such that little or no cold rolling or bending of the cold or warm part need be done. When casting into a metal mold, much of the molten alloys can be poured out of the mold soon after casting and after a desired thickness of Rh, high Rh alloy or other alloy has formed a desired thickness of cooled metal next to the walls of the mold and the desired thickness can be varied by using different materials for different parts of the mold,
2) continuous casting of a thin strip of high hot creep and sag resistant metal and alloy by rotating a cylinder at an appropriate speed with a portion slightly submerged in the molten metal or alloy followed by pulling, stripping or otherwise removing the strip from the surface of the rotating cyliinder as soon or shortly after the thin metal strip has solidified,
3) casting into bars or plates and further formed into shape by hot pressing, hot forging and hot rolling at temperatures above 2000 degrees F. With the techniques of (1) and (2) above, the addition of small percentages of other metals can be included in the alloys to increase malleability, formability, or to further increase hot creep resistance and other desiravle properties or both. Such other metals include, but are not limited to Rhenium, Boron, Zirconium, Tungsten, Iridium, Ruthenium, and Osmium. In this method and the method(s) described above (1), to obtain a better bond between metal or metal alloy plates and other sidewall plate(s) and the molten metal or metal alloy and/or to affect the thickness along the parts of a 5 sided box when desired, a burner shaped to fit inside or just above a mold with the same or different flame jets directed in the appropriate areas of the inside of the mold can be used to preheat the insides of the mold prior to filling the mold with the metal or metal alloy,
4) casting a high temperature melt of high Rh alloys, Rh above 25 wt. %, above 30% and above 35%, etc., into a water cooled (or cooled any way) cavity by casting onto an Rh metal layer or a very high Rh alloy, e.g. 40 wt. % Rh or higher layer or into a 5 sided box of such a metal layer inside a cooled cavity. The Rh or very high Rh alloy layer will sinter or bond to the cooling cast metal and provide a very high hot strength and resistance to high temperature creep of the bushing or other article made from the high Rh alloy, and the metal layer(s) that are cast against can be of the same or varied thickness if desired,
5) casting a low Rh alloy, e.g. 95-80 wt. % Pt/5-20 wt. % Rh alloy against a very thin plate or very thin walled 5 sided box of high Rh alloy of 25-50 wt. % Rh or higher, the remainder being Pt, and quickly pouring out the still hot low Rh melt leaving a thin layer of the low Rh alloy cooled and bonded to the high Rh alloy to form a laminate, the high Rh alloy having a high creep resistance on the outside or tension side of the laminate, followed by the normal steps of finishing the part, bushing, etc.,
6) using traditional powder metallurgy forming followed by high temperature consolidation or sintering, optionally cooling the high Rh alloys in cryogenic liquids, like liquid Nitrogen, prior to grinding, etc. the cooled alloy into powder,
7) using the high Rh alloys to make the simple shapes including a bottom plate having a plurality of holes therein to support a tip plate, but use a more easily formed alloy, including 75-90 Pt/10-25 Rh alloys, to make the tip plate with the tips passing through the holes in the high Rh support plate and with the edges of the tip plate welded to the high Rh support plate or to the high Rh bushing walls or to both,
8) improving the forming properties of the high Rh alloys by adding one or more other metals that will improve the mallubility of the high Rh alloy, e.g. an effective amount of Rhenium, Palladium, Boron or similar metal with Rhenium being the preferred additive metal,
9) using a combination of rapid prototype printing (3D printing) to form part or the entire part, including glass fiberizing bushings, followed by high temperature consolidation or sintering. Also, with slurries containing small particles of Pt/Rh alloys, and other precious metals and PM alloys of all types including Pt/Pd, Pt, Ir, Pt/Rh, Pt/Ru, etc., preferably alloys containing more than 10% Rh as well as the high Rh alloys described above to make bushings and other PM items, followed by sintering to consolidate the parts to make them contain and/or fiberize molten glass, etc., then sintered to form the part with no or minimum machining and/or welding needed after cooling, and/or
10) laying down one layer at a time of powder of refractory precious metal or precious metal alloy and then using selective laser sintering or selective laser melting, those parts of the layer forming the part can be fused or sintered to progressively to build up the part or bushing or other article being made.

Further, combinations of two or more of these techniques can be used such as adding one or more property enhancing metals followed by any of the above described forming or fabricating techniques. Also, when a numerical range is used to describe the invention it is to be understood that all ranges and integers included within this range are also described, e.g. when a range above at least about 25 wt. percent to above at least about 43 wt. percent is disclosed this includes more than about 30 wt. percent, more than about 35 to more than about 40 wt. percent and many other ranges and amounts above 41, 42 and 43 wt. percent.

The invention includes parts made of Pt—Rh alloys containing at least about 25 to at least about 43 vol. % Rh and made by one or more of the processes described above and in more detail later in this specification as well as the methods of making these parts. More typically the Rh content of the alloy is at least about 25, 30, 35, 40, 43 or at least 45 vol. % Rh and more typically is at least about 53.5, 55, 60, 61, 62 or 65 vol. % of the Pt-Rh alloy. Most typically, the Rh content of the Pt-Rh alloy will be at least 61 vol.% up to at least 80, 85, 90, 95 or 97 vol. % of the alloy. Converting 25 vol. % Rh to Rh weight %=about 16.15 wt. % Rh, and converting 55 vol. % Rh to wt. % Rh is about 41.44 wt. % Rh, and converting 40 wt. % Rh to vol. % is about 53.5 vol. % Rh.

In some embodiments of the invention the parts are a portion, or all, of a fiber forming bushing for high temperature melts of glass or inorganic material at temperatures of at least 2000 or 2100 degrees F. Some parts include a bottom plate, often called an orifice plate or a tip plate, supports or a support plate for the tip plate, tips for the tip plate, screens for bushings, electrical terminals at each end of the bushing and at least portions of side and/or end walls of the bushing. Other parts typically include crucibles, nozzles and plungers for draining high temperature melts having temperatures exceeding 2000, 2100, 2200, 2300, 2400 or 2500 degrees F. or higher from furnaces, melters and conditioning tanks, linings for near and below glass line and bottoms of furnaces, melters and conditioning tanks or channels or distribution legs containing melts of glass or inorganic materials. In some embodiments the parts are heating elements, aside from electrically heated parts of a bushing, such as heating elements for high temperature furnaces, especially special atmosphere furnaces filled with inert or slightly reducing gases. In other embodiments the parts can be parts used in making and using machines and robots for working in temperatures above about 2000 degrees F. or higher, such as in furnaces of many types.

The alloy parts of the invention can also contain small amounts, usually less than about 1-3, 2-5 or 5-10 wt. % of one or more of other elements from a group that includes boron, cerium, molybdenum, zirconium, osmium, palladium, rhenium, ruthenium, iridium, lanthanum, magnesium, titanium, tungsten, yttrium and niobium to improve one or more of malleability, workability, oxidation resistance and/or hot creep resistance.

The invention includes a bushing for making fibers from glass melts, rock melts, slag melts and ceramic melts, the bushing containing one or more high Rh content Pt—Rh alloy parts wherein the alloy contains at least about 44 vol. % Rh, and preferably more than 53.5 vol. % Rh.

The alloy parts of the invention can be made according to the invention using a system and by a method comprising;

a) partial vacuum melting, melting in presence of an inert gas or other conventional melting method a mixture comprising at least about 25-50 wt. % Rh with the remainder being Pt, optionally with one or more other metals to form an alloy,

b) casting into a cooled metal mold or a refractory powder particles in wax (lost wax process), preferably in a partial vacuum or in an inert gas atmosphere,

c) removing and cleaning the cast high Rh/Pt alloy or other alloy part, and

d) optionally hot pressing, hot forging, or hot rolling the cast part to further shape the part.

The alloy parts of net shape or near net shape of the invention can also be made according to the invention by a method comprising;
a) pressing a mixture of Rh particles and Pt particles comprising at least about 25-50 vol. % Rh and at least about 40 vol. % Pt at temperatures ranging from 50 degrees F. up to about 2500 degrees F. or higher to form a consolidated part,
b) optionally sintering the consolidated part at temperatures and times to achieve at least 95% of theoretical density of the alloy formed, and
c) cooling the sintered high Rh/Pt alloy part.

The alloy parts of the invention can also be made according to the invention by a method comprising;
a) hot pressing a piece of metal of high Rh/Pt alloy or a mixture of Rh particles and Pt particles comprising at east about 25-50 wt. % Rh and at least about 35 vol. % Pt, optionally with one or more other metal particles at temperatures ranging from 1800 degrees F. to about 2500 degrees F. or higher to form a consolidated part having at least 95% of theoretical density of the alloy used, and
b) cooling the hot pressed high Rh/Pt alloy part.

Another embodiment of the invention includes,

a) forming a plate to act as a support plate for a tip plate of a bushing using any of the methods described above,

b) drilling holes in the support plate that align with tips on a tip plate to be used on top of the support plate, the holes having a diameter larger than the outside diameter of the tips to allow for variations in tip spacing and to allow for differential thermal expansion and contraction of the support plate with respect to the tip plate.

In any of the systems and methods of making high Rh alloy parts the mallaebility and the forming properties of the high Rh alloys can be improved according to the invention by adding one or more other metals in an effective amount, usually less than 10 wt. percent. Some suitable metals include, but are not limited to Rhenium, Palladium, Boron or similar metal with Rhenium being the preferred additive metal.

Another system and method of making high Rh alloy parts, and even all or most of a fiberizing bushing according to the invention, especially since such bushings and some parts are very complex, is to use a combination of rapid prototype printing (3D printing) to form parts or the entire device, including glass fiberizing bushings, optionally followed by high temperature consolidation or sintering where necessary or desired.

It is preferred to melt, preferably by induction melting, the desired mixtures of precious metals, usually in the form of ingots or partial ingots, or in the form of used parts, or portions of used parts, in a partial vacuum to avoid any oxidation and gas bubbles being trapped in the melt, or in an inert gas atmosphere to avoid any oxidation, but the melting can also be carried out in air. It is also preferred to cast the alloy melts in a partial vacuum or inert gas atmosphere for the same reasons. This is also preferred for the hot pressing and sintering steps of the other forming processes used.

Parts made by some of these systems and methods, e.g. casting and rapid prototyping or 3D printing coupled with SLS or SLM, can produce net shape parts or very near net shape parts that require none or very little annealing as very little, if any, stresses are created in the parts due to these forming processes. Such parts perform in a superior manner because of their composition and because of non-stressed internal structures. These parts also can be made faster requiring none or substantially fewer time consuming annealing steps, and their cost is lower than conventional parts due to their composition and longer lives of the parts and/or assemblies of which they are a part. For example, by resisting hot creep, the average fiberizing efficiency (percent of melt converted to salable product) of bushings containing one or more parts made according to the invention is substantially higher than achieved with conventional bushings and this increase in fiberizing efficiency is very valuable to fiber manufacturers. The cast parts can also be cast in width that is net size, but with the length being long enough for two or more parts, followed by cutting the two or more parts apart at the desired lengths. The thickness can be net shape or very near net shape with only slight grinding or milling to achieve a planar surface on the exposed surface, followed by drilling any holes desired in the cast part. The casting mold(s) can be preheated in any suitable manner, and kept at a temperature high enough to alloy the molten alloy to fill out the mold and achieve a satisfactorily uniform thickness before solidifying using flame burners trained on the molds prior to casting and molten metal in the molds until filled. Any holes desired in the parts can be formed in the part while being made, or can be drilled in a conventional manner after the part(s) have been cooled and cleaned, or if necessary ground or milled and/or polished to a uniform or desired thickness.

As an option to the Selective Laser Sintering (SLS) and Selective Laser Melting (SLM) processes mentioned earlier for making bushings, bushing parts and other items normally made from precious metals and/or presicious metal alloys, and new items made therefrom, the composition of the metal and/or alloy powder used in these processes can be varied and changed as the process progresses such that the part can be made of two or more different compositions to address different conditions or requirements of the part will be exposed to, and/or to reduce costs. To enable separation later of the two or more powders of different composition, a very thin thin layer, such as in the range of about 0.25 mm to about 5 mm, preferably from about 0.5 mm to about 1.5 or 2 mm, of material such as a layer of paper, polymer, metal foil made from a compatible metal or alloy, and/or powder of clay, zirconia, titiania and other known strengthing compounds for precious metals can be used.

The invention also includes fiberizing bushings and other parts for service in contacted with or surrounded by molten glass or molten inorganic elements and compounds made by any combination of the methods of the invention. Bushings for forming fibers from molten materials including molten glasses typically comprise a flange (can be part of sidewalls and endwalls), sidewalls, endwalls, electric terminals or ears, a screen, an orifice or a tip plate, tips and optionally internal reinforcing members for and attached to the orifice or tip plate. Such bushings are well known as shown and described in U.S. Pat. Nos. 7,980,099, 7,434,421, 6,813,909, and the Published Patent Application 20080184743 published Aug. 7, 2008, all the disclosures of which, as well as those of the patents and published patent applications mentioned or cited therein, are incorporated by reference herein. Bushings are sometimes referred to as feeders or filament forming apparatus, but such articles are intended to be included in the invention so long as their purpose is to be part of a system for forming fibers from a melt.

According to the invention, the bushing will comprise at least a cast, pressed and sintered or a hot pressed Pt-Rh alloy containing 41 or more than 41 volume (vol.) % Rh, such as more than 42, 43, 44, 45, 46, 47, 48, 49, 53.5, 55, 60 or 61 vol. % Rh in the Pt—Rh alloy. Preferably this orifice plate or tip plate will be hot pressed or cast. The bushing can contain other parts or all parts of these high Rh platinum—rhodium alloys, particularly the screen and any orifice plate or tip plate reinforcing parts, and also the side and end walls or portions of such that extend below the top of the terminal ears. In the bushings of the invention, any of the parts other than the orifice plate or the tip plate can be a Pt—Rh alloy containing at least 31.5 volume % Rh.

The invention also includes methods of making all kinds of molten glass, all kinds of glass products including glass, and other inorganic, fibers using the fiberizing bushings of the invention in known methods of of making molten glass, and glass products including glass, and other inorganic, fibers.

Herein, when a range of number values is disclosed it is to be understood by those of ordinary skill in the appropriate art(s) that each numerical value in between the upper limit and the lower limit of the range is also disclosed, to at least 0.01 of a full number. Thus in a range of 1 to 10, this includes 2.04 to 10, 3.06 to 8 or 8.50, and so on. The addition of a new limitation in a claim previously stating from 2 to 7 changing it to from 3-7 or 4-6 would not introduce new matter whether those new ranges were specifically disclosed in the specification or not because of this explanation of the meaning of a disclosed broader range, such as 1-10. This meaning of a range is in keeping with the requirement in 35 USC 112 that the disclosure be concise.

When the word “about” is used herein it is meant that the amount or condition it modifies can vary some beyond that stated so long as the advantages of the invention are realized. Practically, there is rarely the time or resources available to very precisely determine the limits of all the parameters of one's invention because to do so would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors' disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term “about” as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF THE DRAWINGS

FIG. 1 is a perspective view of a prior art glass fiberizing bushing.

FIG. 2 is a partially cut away perspective view of another prior art bushing.

FIG. 3 is a perspective cross section of a prior art bushing similar to the bushing shown in FIG. 1.

FIG. 4 is a partial cross section of a mold for casting molten Rh and alloys according to the invention.

FIG. 5 is a partial cross section of the mold of FIG. 4 after molding a 5 sided box of Rh or alloy according to the invention.

FIG. 6 is a partial cross section of the mold of FIG. 4 and the 5 sided box of Rh or alloy shown in FIG. 5 after molding a second layer of a different metal against the first layer.

FIG. 7 is a partial cross section of the mold of FIG. 4 having a thin layer of plates, of Rh or a high Rh alloy lining the mold.

FIG. 8 is a partial cross section of the the mold of FIG. 5 lined with the thin layer of plates just after filing with molten metal or alloy according to the invention.

FIG. 9 is a partial cross section the mold of FIG. 5 after the molten metal(s) or alloy(s) has/have been poured out leaving one or more layers of Rh, high Rh alloy and/or a different alloy have formed by initial cooling.

FIG. 10 is a partial cross section of a portion of a a fiberizing bushing made according to the invention having edges of a tip plate welded to a bottom plate of the bushing.

FIG. 11 is a partial cross section of a portion of a a fiberizing bushing made according to the invention having edges of a tip plate welded to sides and ends of the bushing.

FIG. 12 is a partial cross section of an apparatus and process for continuously forming a thin strip from molten metal or metal alloy according to the invention.

### DETAILED DESCRIPTION OF THE BEST MODE AND SOME OTHER EMBODIMENTS

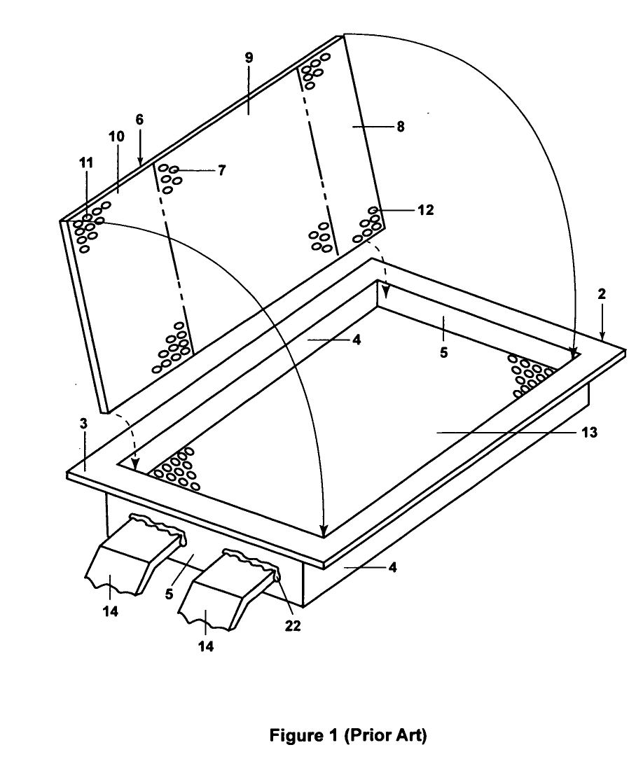

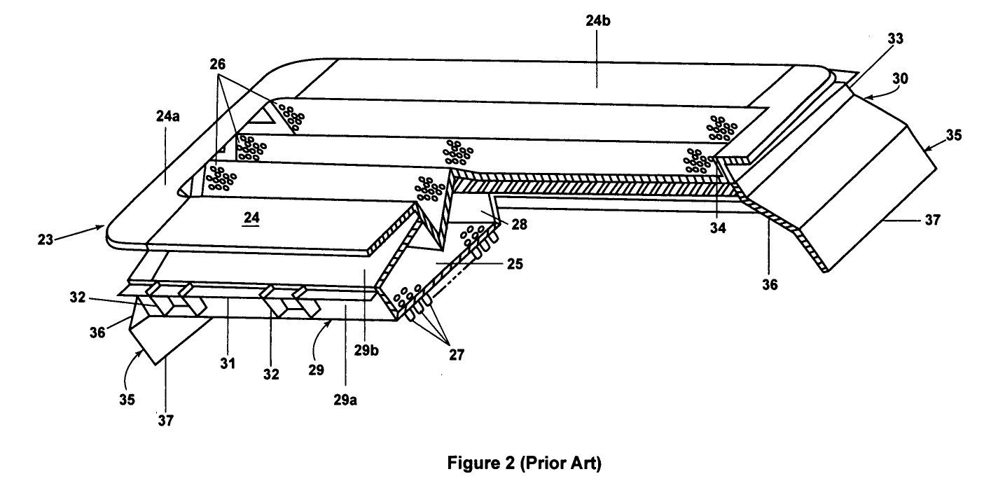

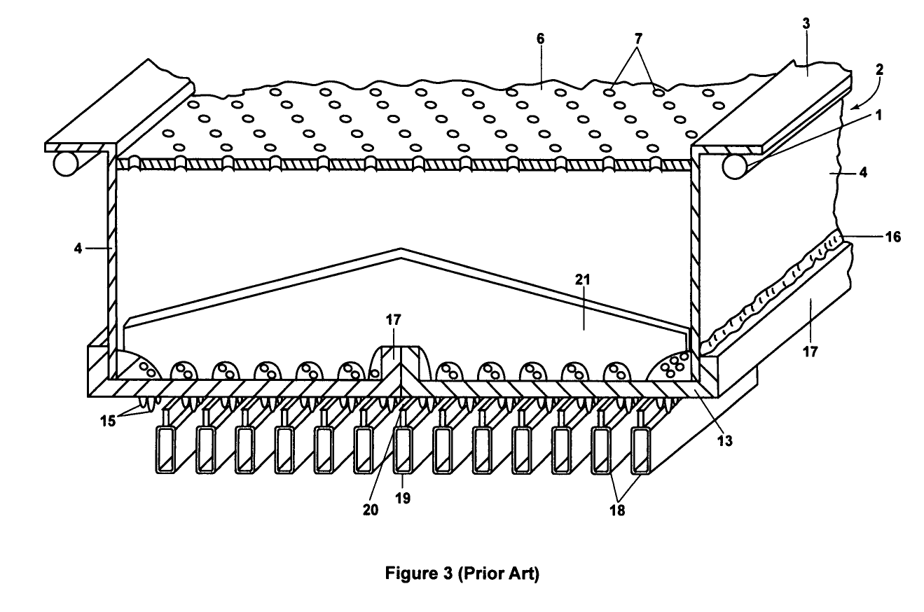

FIG. 1 is a perspective view of a prior art glass fiberizing bushing, a bushing Shown and described in U.S. Pat. No. 7,194,874, the disclosure of which is hereby incorporated herein by reference. Such a bushing is typically made of a precious metal alloy of about 80 wt. % Pt and about 20 wt. % Rh. This bushing receives molten glass from a forehearth and forms fibers from thousands of tips that are rapidly pulled away from the bushing and attenuated while hot and plastic to various desired diameters as known. This bushing 2 is comprised of a flange 3 that butts against a bottom of a flow block in the forehearth, two opposed sidewalls 4 and two opposed end walls 5, a screen 6 (shown unattached here) having spaced apart holes 7 to catch any pieces of refractory carried by the glass flow and also to mix and homognize the molten glass. The screen 6 can have uniform diameter holes 7 evenly spaced apart in the screen (see FIG. 2) or can, as shown here, have sections 8, 9 and 10 with each section having same or different diameter holes 7, 11 and 12, with same or different spacing between the holes for the purpose of evening out the temperature of a tip plate 13 and tips 15 (see FIG. 3). The flange 3, walls 4, 5, screen 6, and orifice or tip plate 13 can each be made in one piece and bent at the corners, or can be individual pieces and welded at the joints. The bushing 2 is electrically heated by applying power to two or more ears or terminals 14, here attached by welds 22.

FIG. 2 is a partial cut away perspective view of another prior art bushing 23 shown and described in U.S. Pat. No. 8,001,807, the disclosure of which is hereby incorporated herein by reference. The bushing 23 comprises a tip plate 25 having attached thereto a plurality of spaced apart tips 27 through which glass flows to form fibers, a screen 26 bent into a plurality of integral V shaped sections, one or more spaced apart reinforcing members 28 running across the length, and/or width, and attached to the top surface of the tip plate 25, opposing sidewalls 29, 30, each sidewall having two sections 29a and 29b on two separate planes. This bushing 23 also comprises one or more support rails 31 and support brackets 32 for securing the bushing 23 to a bushing frame (not shown), a lower portion 33 of wall 30 adjacent to the tip plate 25, an upper portion 34 of the end wall adjacent to the screen 26. A terminal ear 35 is attached to each end of the bushing 23, each terminal ear 35 having an upper portion 36 and a lower portion 37.

FIG. 3 shows a perspective cross section of a prior art bushing 2 similar to the bushing shown in FIG. 1, but with some modifications and showing more details of a bushing assembly. This bushing 2 is also described in U.S. Pat. No. 7,194,874 (see above). FIG. 3 shows a chilled water tube 1 that is positioned against an underside of the flange 3 to cool and solidify any molten glass that tries to flow through, forming a seal against glass leaks. In this bushing 2, the tip plate 13 is formed of two separate sections with each section having turned up side end portions 17. The outside turned up end portions 17 are welded to the side walls 4 with welds 16. Inside turned up end portions are welded together (not shown here) and also on the bottom of the tip plate (welds not shown here). The inside turned up end portions running down the length of the tip plate 13 provides reinforcement against bowing down of the tip plate 13 due to hot creep during operation. Also, multiple stiffners 21 spaced apart down the length of the bushing 2 with the bottom portions welded to the tip plate 13 and ends in a known manner reinforces the tip plate 13 from bowing down across its width due to hot creep. The tips 15 are either integral with the tip plate 13 or are made separately and welded to the tip plate 13 on the inside surface of the tip plate 13. The tips are cooled by air and by cooling tubes 18 containing flowing chilled water and each having a fin running down the center of the top of the cooling tubes 18. A center cooling tube 19 has two spaced apart fins 20 running down the top of the center cooling tube 19.

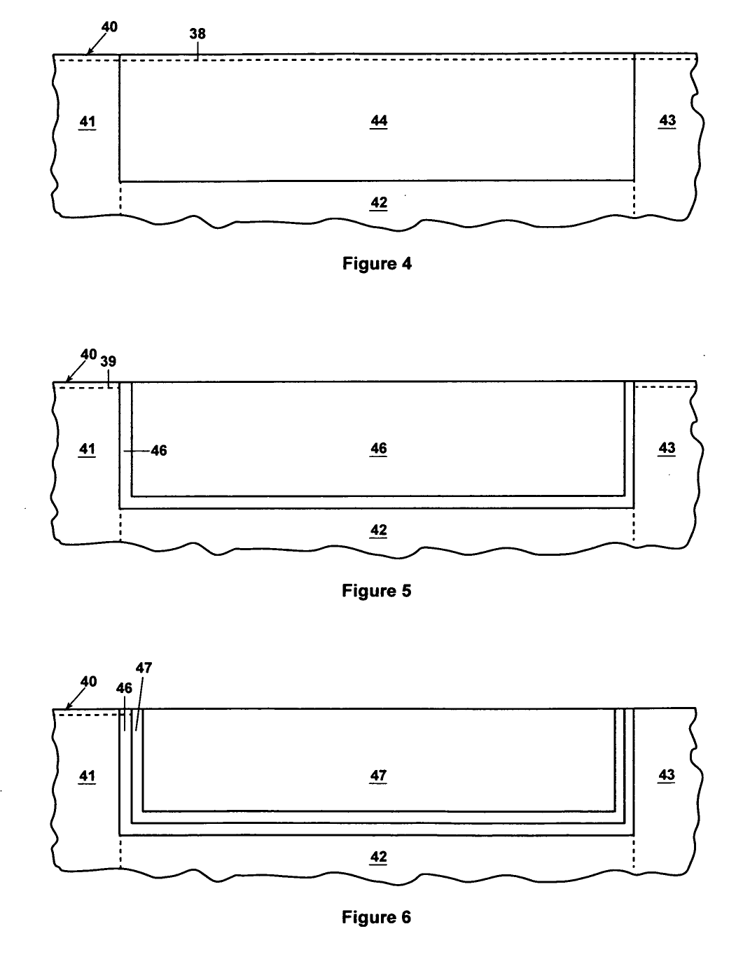

FIG. 4 is a partial cross section of a typical mold 40 used in the invention comprised of two ends 41,43, a bottom 42, a back side 44 and a front side (not shown). This mold 40 can be in one integral piece, but usually is made up of separate pieces named above to more easily remove a solid cast piece, plate, ingot, or 5 sided box. Optionally, the mold 40 can be modified as shown by the dashed line 38 to to form an integral flange 39 (see FIG. 5) on a 5 sided box. The thickness of the pieces can be the same or variable and the mold can be cooled in some manner, especially for casting ingots, or not cooled when making thin plates, boxes, or other than ingots. The mold 40 or separate mold parts 41, 42, 43, 44 and the other sidepart can be of the same high melting point material normally used to cast precious metal alloys, or can be different materials. For example, if when making a 5 sided box it is desirable for the its bottom to be thicker than the end and side walls, the bottom part 42 of the mold 40 can be of a material having a significantly higher coefficient of thermal conductivity than that of the other parts of the mold, i.e. one or more parts of the mold 40 can be of different materials to affect the thicknesses of various parts of a plate, portions of a 5 sided box, with or without a top flange 39 or portions of other part shapes.

FIG. 5 shows the partial cross section of the mold of FIG. 4 after having been filled with a molten metal or molten metal alloy used in the invention and very soon thereafter having been rotated, etc., to dump out the molten metal or molten metal alloy forming a 5 sided box 46 having thin walls of desired thickness. To affect the thickness along the parts of the 5 sided box 46, if desired, a burner shaped to fit inside or just above the mold 40 with the same or different flame jets directed in the appropriate areas of the inside of the mold 40 can be used to preheat the insides of the mold 40 prior to filling the mold 40 with the metal or metal alloy. This 5 sided box 46, without any joints, can then be further fabricated into a fiberizing bushing such as those shown in FIGS. 1-3 by welding on ears, a flange if not already on the box 46 and by adding tips to the bottom plate 42 by conventional means or by drilling oversize holes in the bottom plate 42 followed by welding the edges of a conventional tip plate, preferably with a thinner plate of the tip plate and longer tips than conventional, inside the 5 sided box 46 as shown in FIGS. 10 and 11. Using this process allows easier and/or less costly production of a plate, other shape and 5 sided box, particularly the later two categories, using high hot creep strength metals or metal alloys having poor malleaibilities and other forming properties that make it difficult to bend and otherwise form the metals or metal allowys, such as Rh, high Rh or other alloys containing Ru, Os, Ir, etc..

FIG. 6, a partial cross section of a mold 40, shows a modification of the process and resulting cast plate, part or 5 sided box. In this embodiment of the invention, a still different molten metal or metal alloy can be poured into the mold 40 containing the lining of solid metal or metal alloy layer 46 and then poured out after a second metal or metal alloy layer 47 has been formed to form a two layer laminate. For example, the second layer 47 could be a layer easier to form tips, following the removal of all or most of the first layer 46 in the area of the tips on a bushing such as those of FIGS. 1-3, a material more suitable for contacting molten glass or other molten material, a less costly material or a combination of two or more of these advantages. Also, laminates having more than two layers could be formed in this manner in which a middle layer could be formed of a metal, metal alloy or other material having hot creep strength and hot sag resistance desired, but undesirable resistance to oxidation. Thin outer layers of metal or metal alloys having good or excellent resistance to oxidation at operating temperatures of the parts, box, etc. would produce superior performing (higher fiberizing efficiencies, more uniform fiber diameters, etc.) parts and apparatus, and/or also having longer operating lives.

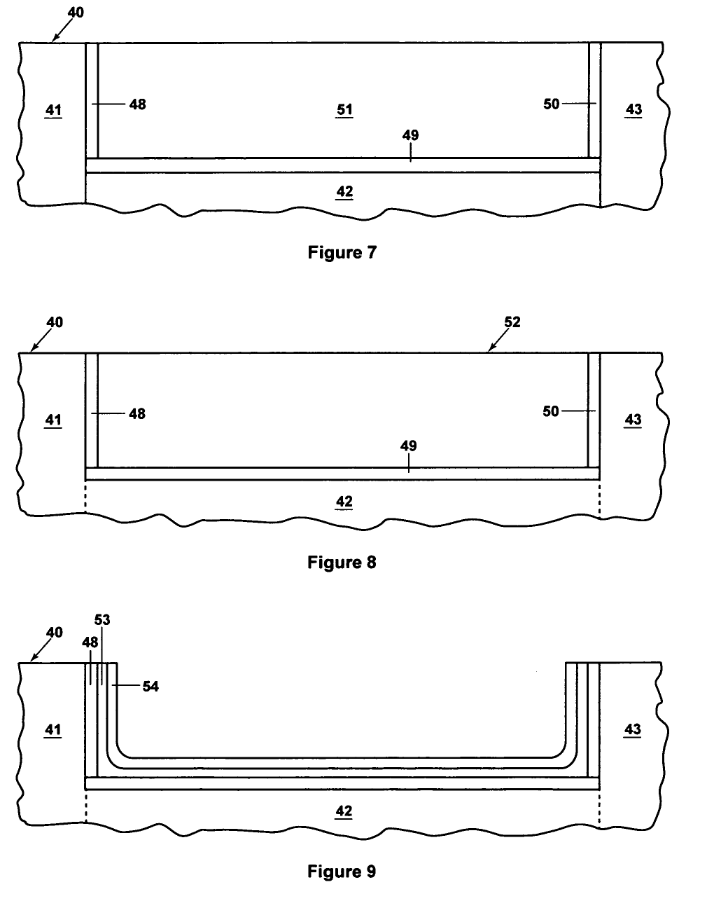

FIG. 7 is a partial cross section of the mold 40 having a lining comprising end walls 41,43, a bottom 42 and two unshown sidewalls, the mold 40 being lined with unbonded end plates 48,50, a bottom plate 49 and two side plates 51 (one not shown). Though not necessary, it is preferred that the end plates 48, 50 are set on top of end portions of the bottom plate 49. These plates 48-51 and the unshown side plate can be any of the refractory metals or precious metals disclosed herein or alloys of two or more of any of these metals to either provide high hot creep and sag resistance or to provide good hot creep and sag resistance and good or excellent oxidation resistance at temperatures of 1800 degrees and above. The arrangement shown in FIG. 7 is for casting plates, other shape parts or a 5 sided box with a molten refractory or precious metal or any alloy thereof according to the invention. The thickness of the plates 48-51 and the unshown sidewall plate can vary and be different to perform in the desired manner. For example, if the purpose is to provide good to excellent oxidation resistance the thickness can be very thin, but if to provide high hot creep and sag resistance, the thickness will be substantially thicker. To obtain a better bond between the metal or metal alloy plates 48. 49. 50. 51 and other sidewall plate and the molten metal or metal alloy 52 and/or to affect the thickness along the parts of the 5 sided box 46 when desired, a burner shaped to fit inside or just above the mold 40 with the same or different flame jets directed in the appropriate areas of the inside of the mold 40 can be used to preheat the insides of the mold 40 prior to filling the mold 40 with the metal or metal alloy. FIG. 8 shows the arrangement of FIG. 7 filled with a molten metal 52 or metal alloy described above.

FIG. 9 is a partial cross section of the mold 40 containing the lining comprised of plates 48-51 and an unshown sideplate with a layer 53 of the molten metal or alloy 52 that will bond to the lining 48, etc. forming a layer followed by pouring out the the still molten metal or alloy 52 after a desired time to form the solidified layer 53. Then, immediately following the dumping of the molten metal or alloy 52, a different molten metal or alloy can be poured into the still hot mold 40 and against the still hot, but solidified, layer 53 to form a third solidified layer 54, after which the still molten third metal or alloy is poured out forming a laminate of three layers. A similar technique can be used to form a 3 or more layer laminate using the process shown in FIGS. 6-8 or FIGS. 6-9.

FIG. 10 is a partial cross section of a portion of a fiberizing bushing 60 comprising a flange 61, a sidewall 59, an end wall 62 and a bottom plate 63. At least the bottom plate 63 is a high hot creep and sag resistant metal or metal alloy having poor malleability and/or drawing properties making it extremely difficult to form tips in the bottom plate 63. According to some embodiments of the invention this is overcome by the techniques including those shown in FIGS. 10 and 11. In these embodiments, spaced apart holes 65 are formed in the bottom plate 63 by drilling, punching or other known method. The centers of the holes 65 are located according the tip centers desired on the bushing and the diameters of the holes 65 are such as to accommodate variation of spacing of tips 64 in/on a tip plate 66 and also to accommodate differential thermal expansion and contraction between the tip plate 66 and the bottom plate 63. This tip plate 66 can be made from a metal or metal alloy suitable for making tip plates by conventional means for use in fiberizing bushings, a metal or metal alloy having good malleability and drawing properties while having lower hot creep and sag resistance than the metal or alloy of the bottom plate 63. The tips 64 can be made longer than those of a conventional tip plate so that they extend the same or nearly the same distance below the bottom plate 63 as they would extend below a conventional tip plate on a conventional bushing. The edges of the tip plate 66 can lie inside the edges of the bottom plate 63 and be attached with welds 67, of a conventional type used in welding in bushings, along the edges of the tip plate 66 to the top of the bottom plate 63. As shown in FIG. 11, alternatively the tip plate 66 can also have turned up sides 68 with the edges attached to the end wall(s) 62 and sidewall(s) 59 with a weld 69. When a screen is desired in the bushing, the screen is attached to the inside of the bushing in a conventional manner after the procedures shown in FIGS. 10 and 11 are finished.

The invention also includes improving the forming properties of the high hot creep and sag resistant metals and alloys such as high Rh content alloys and Pt/Rh/Os and/or Ir and/or Ru alloys by adding one or more other metals that will improve the mallubility of such alloys, e.g. an effective amount of Rhenium, Palladium, Boron or other metal performing the same or similar function, Rhenium being the preferred additive metal, with or without small amounts of Boron.

In any of the methods shown in FIGS. 4-11, and the description thereof, the thickness of the cast metal layers can be controlled by preheating one or more of the mold parts in a furnace to an appropriate temperature to control the rate of metal thickness solidification next to the mold part wall to form a substantially uniform thickness of all the walls of the cast part, or to cause one or more walls to be thicker than the other walls. For example, when using these methods to cast a five sided box of a fiberizing bushing where it is desired that the tip plate, orifice plate or support plate be thicker than the walls of the bushing, the parts of the mold adjacent to the walls of the box can be preheated to a higher temperature than the bottom mold part adjacent to the bottom wall of the box which will allow a faster rate of metal solidification next to the bottom mold part from the molten alloy. Since the rates of solidification from the melt will depend upon many variables including the composition of the melt, the temperature of the melt, the thermal conductivities of the various mold parts, the ambient temperature in the molding room it will be necessary to determine the actual preheating temperatures with each desired alloy and desired result by trial and error.

Further since the preheating and removal of preheated molds or mold parts, their assembly, the melting of the alloy(s), the casting process, the emptying of the molten alloy from the mold after a short time, the moving of the hot mold and solidified layer, layers, five sided box or other shape to a cooling area, and possibly the disassembly of hot molds to remove a hot solidified part and reassembly and placement into the preheating furnace will be very hot, too hot for people to work in, known robots having the appropriate handling and manipulating capability can be used for these operations. The robot or robots will have the capability to function in an elevated temperature environment of up to 600 or 1000 or 1500 degrees F. or even higher. Such robots can also be used in the hot pressing, rolling and forging of hot alloy shapes in the fabrication of alloy parts including fiberizing bushings, forehearth linings and linings for all purposes and other high temperature parts.

FIG. 12 is a partial cross section of another system and process for making thin metal or metal alloy strips or parts for use in making apparatus such as fiberizing bushings, stirrers, and other molten glass contacting or heating or holding apparatus. In this process a refractory furnace such as an induction heated furnace 70 contains a melt 72 of a refractory metal and/or a precious metal or alloys thereof while a rotating cylinder 73 has a portion of its circumference slightly submerged in the melt 72. The cylinder 73 can have a sleeve 75 of a material compatible with the melt 72 that is maintained at a temperature lower than the melting point of the melt 72 such that as the sleeve 75 rotates in the melt 72 a layer 74 of solidified melt builds up to the desired thickness of a strip or sheet 80 by the time the sheet 80 leaves the melt 72. The sheet 80 continues to cool as the cylinder 73 rotates until the sheet 80 is removed from the sleeve 75 either by pulling on the continuous sheet or strip 80 by an optional set of pull rolls 79, is separated by a plow 77, both or some other conventional means. The sleeve 75 can be maintained at the desired temperature with cooling air or other fluid circulating within the cylinder 73, blown on its outer surface, or both. This process is typically used on other metals and alloys of lower melting points for making fiber, wire and narrow strips. Here in this invention it is used to make thin strips of a few or several inches wide and thicknesses of from 0.01 up to about 0.12 inch thick or thicker. Wider thin metal or metal alloy sheets of the disclosed compositions can also be made using the system shown in FIG. 12.

Parts, sub-assemblies and apparatus including fiberizing bushings of the invention, using refractory metals and/or precious metals and alloys disclosed herein, can also be fabricated using a combination of various layer by layer fabrication plus later firing (to remove most or all of any organic resin or material) followed by and sintering, or using selective hot air or laser sintering or melting on layer(s) as the product is being built up. Processes like rapid prototype printing (3D printing, additive manufacturing), and equivalents by other names, to form part or the entire part, either in combination with selective laser sintering (SLS) or selective laser melting (SLM) and/or high temperature consolidation or sintering. Also, by using slurries containing small particles of Pt/Rh alloys, and other precious metals and PM alloys of all types including Pt/Pd, Pt, Ir, Pt/Rh, Pt/Ru, etc., preferably alloys containing more than 10% Rh as well as Re and the high Rh alloys described herein to make bushings and other PM items, followed by sintering to consolidate the parts to make them contain and/or fiberize molten glass, etc., then sintered to form the part with no, or minimum machining and/or welding, needed after cooling.

Stereo lithography (STL) uses a resin photo polymer resin that is selectively hardened by a laser beam delivering UV light at desirable spots on each thin resin layer. Fused Deposition 30 Method (FDM) uses a plastic mixture containing the metal and/or alloy particles that is forced through a hot nozzle that deposits the material to form each layer. Laminated Object Manufacturing (LOM) of laminates using cut sheets of a special paper containing metal or alloy particles in desired patterns to create 3D parts. The parts and apparatus formed with these processes are later fired and sintered to consolidate the metal and/or alloy particles into a non-permeable solid. Also, instead of using slurries of PM and PM alloy particles, layers of dry powder can be laid down one at a time and then using selective laser sintering or selective laser melting, those parts of the layer forming the part can be fused or sintered to progressively build up the part or bushing or other article being made. Some smoothing by drilling of the holes in the tips, and burnishing or polishing of the flange top and ear surfaces, may be required for optimum performance. Such processing methods as disclosed patents such as U.S. Pat. Nos. 6,589,471, 6,814,926, 7,241,415, 7,291,242, 8,524,142, the disclosures of which are hereby incorporated herein by reference.

Also, with respect to the process of FIG. 12, several techniques can be used to control the thickness of the formed strip or sheet 80. One method is to change the temperature of the cooling fluid 73 passings through the cylinder and/or the flow rate of the cooling fluid 73 through the cylinder 35. Another method that can be used alone or in conjunction with one or more of the methods just described is to mount one or more thickness sensors in a known manner to continuously monitor the thickness of the strip or sheet 80 and to adjust, preferably automatically, the speed of rotation of the cylinder 75, faster to make the strip or sheet thinner and slower to make it thicker.

Another alloying metal that is desirable for alloys containing rhodium and rhenium is nickel which can be present in these alloys in amounts up to 25 wt. percent, but preferably in amounts below 20 wt. percent such as 5-20 wt. percent or 1-10 wt. percent.

Different embodiments employing the concept and teachings of the invention will be apparent and obvious to those of ordinary skill in this art and these embodiments are likewise intended to be within the scope of the claims. The inventor does not intend to abandon any disclosed inventions that are reasonably disclosed but do not appear to be literally claimed below, but rather intends those embodiments to be included in the broad claims either literally or as equivalents to the embodiments that are literally included.

I claim:

1. Parts having good hot creep resistance at temperatures of at least 2,000 degrees F., the composition of the parts being a precious metal alloy comprising at least 25 vol. percent of rhodium, rhenium in amounts up to at least 25 vol. percent, a major portion of the remainder being platinum.

2. Parts of precious metal alloy comprising at least 41 vol. percent rhodium and/or rhenium, a major portion of the remainder being platinum and less than 10 wt. percent of one or more of boron, cerium, molybdenum, zirconium, osmium, palladium, ruthenium, indium, Iridium, lanthanum, magnesium, titanium, tungsten, yttrium and niobium.

3. The parts of claim 1 wherein the rhodium content is at least about 53.5 wol. Percent.

4. The parts of claim 2 wherein the rhodium content is at least about 53.5 wol. Percent.

5. The parts of claim 1 wherein the part also contains a significant amount of nickel.

6. The parts of claim 2 wherein the part also contains a significant amount of nickel.

7. The parts of claim 1 being suitable for extended contact with molten glass at temperatures of at least 2,000 degrees F.

8. The parts of claim 2 being suitable for extended contact with molten glass at temperatures of at least 2,000 degrees F.

9. The parts of claim 3 being suitable for extended contact with molten glass at temperatures of at least 2,000 degrees F.

10. The parts of claim 4 being suitable for extended contact with molten glass at temperatures of at least 2,000 degrees F.

11. The parts of claim 5 being suitable for extended contact with molten glass at temperatures of at least 2,000 degrees F.

12. The parts of claim 6 being suitable for extended contact with molten glass at temperatures of at least 2,000 degrees F.

13. The parts of claim 1 wherein the rhodium content is greater than about 44 volume percent.

14. The parts of claim 2 wherein the rhodium content is greater than about 44 volume percent.

15. The parts of claim 1 wherein the rhodium plus rhenium content is greater than about 61 volume percent.

16. The parts of claim 2 wherein the rhodium plus rhenium content is greater than about 61 volume percent.

17. The parts of claim 1 wherein a portion of the part is an alloy of about 80 wt. percent platinum and about 20 wt. percent rhodium.

18. The parts of claim 2 wherein a portion of the part is an alloy of about 80 wt. percent platinum and about 20 wt. percent rhodium.

19. A method of forming a precious metal or refractory metal part comprised of at least about 53.5 volume percent of rhodium, with the remainder being one or more of platinum, rhenium rhenium, boron, cerium, molybdenum, zirconium, osmium, palladium, ruthenium, indium, Iridium, lanthanum, magnesium, titanium, tungsten, yttrium and niobium comprising selecting at least some steps from a group of forming techniques selected from the group consisting of:
A) melting the components of the alloy and pouring into a mold to form an ingot, then doing one or more of heating ingots to a temperature above 2000 degrees F., but below its melting temperature, and either hot forging the hot ingot or hot rolling the hot ingot or hot pressing hot alloy or combinations of these steps to form the hot alloy into sheets, strips or parts,
B) pouring molten alloy into a preheated mold to form a five sided box and, after a thin layer of alloy has solidified on the mold's five surfaces, pour the remaining molten alloy out of the mold, further cool the mold and alloy five sided box and separate the five sided box from the mold to obtain the alloy part,
C)) pouring first molten metal or metal alloy into a preheated mold to form a five sided box and, after a thin layer of metal or alloy has solidified on the mold's five surfaces, pour the remaining first molten alloy out of the mold, then pour a second molten metal or alloy into the still hot first metal or alloy box while supported by the preheated mold, after another layer of the second metal or alloy has formed on the sides and bottom of the first metal or alloy box pour the second molten metal or alloy out of the five sided box, further cool the mold and alloy five sided box and either repeat with a different molten metal or alloy and when finished casting, separate the five sided box from the mold to obtain the alloy part,
D) pouring molten alloy into a preheated mold to form a five sided box, wherein the mold section forming the bottom of the box is preheated to a lower temperature than the mold sections forming the sides of the box so that molten alloy will solidify at a faster rate adjacent the bottom of the mold than adjacent to the sections of the mold forming the sides of the box, after a thin layer of alloy has solidified adjacent the mold's four sections forming the sides of the box then pour the remaining molten alloy out of the mold, further cool the mold and alloy five sided box and separate the five sided box from the mold to obtain the alloy part,
E) pouring molten alloy into a preheated mold to form a five sided box, wherein the mold section forming the bottom of the box is preheated to a lower temperature than the mold sections forming the sides of the box so that molten alloy will solidify at a faster rate adjacent the bottom of the mold than adjacent to the sections of the mold forming the sides of the box, after a thin layer of alloy of the box then pour the remaining molten alloy out of the mold, further cool the mold and alloy five sided box and separate the five sided box from the mold to obtain a preliminary alloy part and drill a plurality of holes in the bottom of the five sided box, the centers of the holes spaced apart a distance such that their centers closely match desired centers of fiberizing tips on the bottom of a fiberizing bushing,
F) pouring molten alloy into a preheated mold to form a five sided box, wherein the mold section forming the bottom of the box has a higher coefficient of thermal conductivity than that of the mold sections forming the sides of the box so that molten alloy will solidify at a faster rate adjacent the bottom of the mold than adjacent to the sections of the mold forming the sides of the box, after a thin layer of alloy has solidified adjacent the mold's four sections forming the sides of the box then pour the remaining molten alloy out of the mold, further cool the mold and alloy five sided box and separate the five sided box from the mold to obtain the alloy part,
G) laying down a layer of powdered metal and/or alloy particles, then running an active laser over only the areas of a part to sinter or melt the particles together, then laying down another layer like the first layer and again running the active laser over the area of the part and repeat these steps until a height is reached that matches substantially the height of the part and separate the part from the loose particles, and
H) laying down a layer of powdered metal and/or alloy particles, then running an active laser over only the areas of a part to sinter or melt the particles together, repeat these steps until a height is reached that matches a height where it is desired to change the composition of the part, then laying down a layer of particles of a different metal or a different alloy and continue with particles of the same second composition, or change the composition of the particles again once or more until reaching substantially the height of the part and separate the part from the loose particles.

20. The method of claim 19 wherein the part is at least a part for a fiberizing bushing or a complete fiberizing bushing.
